(19) United States
(12) Patent Application Publication
(10) Pub. No.: US 2026/0277085 A1
(43) Pub. Date: Sep. 17, 2026

(54) LIGHT SOURCE MODULE AND PROJECTOR

(71) Applicant: SEIKO EPSON CORPORATION, Tokyo (JP)

(72) Inventor: Keita TSUKIOKA, MATSUMOTO-SHI (JP)

(21) Appl. No.: 19/562,971

(22) Filed: Mar. 11, 2026

(30) Foreign Application Priority Data
Mar. 12, 2025 (JP) 2025-039139

(51) Int. Cl. G03B 21/14; G03B 21/20; G03B 21/00

(52) U.S. Cl. CPC G03B 21/145; G03B 21/142; G03B 21/2033; G03B 21/006

(57) ABSTRACT

A light source module includes a light source including a light emitting element that emits a light and a substrate on which the light emitting element is mounted, a light guide element having an incident end and an emission end, and uniformizing in-plane illuminance of the light, and a holding member holding the light guide element, wherein the holding member is fixed to the substrate, the holding member has a wall portion forming a side surface surrounding the light guide element, an incident end portion facing the light source in the wall portion, and an emission end portion located at a side opposite to the incident end portion, the incident end portion and the emission end portion penetrate along an optical axis direction of the light, and the wall portion has an opening overlapping the light guide element when viewed from a direction intersecting the optical axis.

### CROSS-REFERENCE TO RELATED APPLICATION

The present application is based on, and claims priority from JP Application Serial Number 2025-039139, filed Mar. 12, 2025, the disclosure of which is hereby incorporated by reference herein in its entirety.

### BACKGROUND

### 1. Technical Field

The present disclosure relates to a light source module and a projector.

### 2. Related Art

There is a known projector of related art including a light source that emits a light, a light modulation device that modulates the light emitted from the light source in accordance with image information to generate an image light, and a projection optical system that enlarges and projects the image light emitted from the light modulation device onto a projection surface such as a screen.

JP-A-2000-180962 discloses a projector including an LED light source that emits a light, a block-shaped light guide element that emits the light emitted from the LED light source from an emission end with uniform brightness, a thecondenser lens that forms a light source image of the light emitted from the light guide element at the incident pupil position of a projection lens, a light modulation element that generates an image light, and the projection lens.

JP-A-2000-180962 is an example of the related art.

However, in the projector described above, in order to improve light use efficiency and illuminance unevenness, it is required to adjust the optical axes of the light guide element and the light emitted from the LED light source.

### SUMMARY

A light source module according to an aspect of the present disclosure includes a light source including a light emitting element that emits a light and a substrate on which the light emitting element is mounted, a light guide element having an incident end on which the light emitted from the light source is incident and an emission end from which the light is emitted, and uniformizing in-plane illuminance of the light, and a holding member holding the light guide element, wherein the holding member is fixed to the substrate of the light source, the holding member has a wall portion forming a side surface surrounding the light guide element, an incident end portion facing the light source in the wall portion, and an emission end portion located at a side opposite to the incident end portion, the incident end portion and the emission end portion penetrate along an optical axis direction of the light, and the wall portion has an opening overlapping the light guide element when viewed from a direction intersecting the optical axis direction of the light.

A projector according to another aspect of the present disclosure includes the light source module according to the aspect, a light combining element that combines a light emitted from the light source module and emits the combined light, and a projection optical system that projects the light emitted from the light combining element.

### BRIEF DESCRIPTION OF THE DRAWINGS

FIG. 1 is a plan view showing a schematic configuration of a projector according to an embodiment.

FIG. 2 is an exploded perspective view of a light source module.

FIG. 3 is a perspective view showing an overall configuration of the light source module.

FIG. 4 is a plan view showing a light source.

FIG. 5 is a perspective view of the light source module with a substrate removed.

FIG. 6 is a perspective view of a light guide element.

FIG. 7 is a cross-sectional view taken along line VII in FIG. 3.

FIG. 8 is a cross-sectional perspective view of a holding member taken along line VIII in FIG. 3.

### DESCRIPTION OF EMBODIMENTS

An embodiment of the present disclosure will be described below with reference to the drawings.

A projector according to the present embodiment is an example of a liquid crystal projector using liquid crystal panels as light modulation devices.

In the following drawings, some component elements may be shown at different dimensional scales for clarity of the respective component elements.

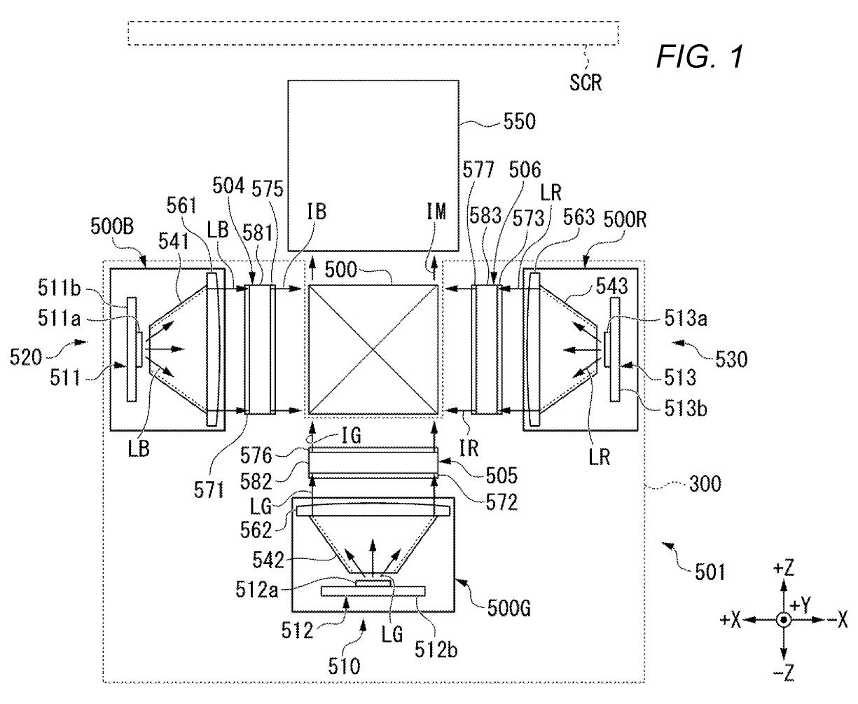

FIG. 1 is a plan view showing a schematic configuration of the projector according to the embodiment.

As illustrated in FIG. 1, a projector 501 is an image display apparatus including three liquid crystal panels as the light modulation devices, and is the so-called 3-LCD projector. The projector 501 includes a green image forming module 510, a blue image forming module 520, a red image forming module 530, a light combining element 500, a projection optical system 550, and a light source holding member 300.

The green image forming module 510 includes a green light source module 500G and a green light modulation device 505. The blue image forming module 520 includes a blue light source module 500B and a blue light modulation device 504. The red image forming module 530 includes a red light source module 500R and a red light modulation device 506.

The light combining element 500 is disposed in a region where the optical path of a blue image light IB emitted from the blue image forming module 520, the optical path of a green image light IG emitted from the green image forming module 510, and the optical path of a red image light IR emitted from the red image forming module 530 intersect one another. The light combining element 500 combines the image lights IB, IG, and IR emitted from a blue light exiting-side polarization element 575, a green light exiting-side polarization element 576, and a red light exiting-side polarization element 577, and emits a generated image light IM toward a +Z side along a Z direction.

The projection optical system 550 is disposed in the optical path of the image light IM emitted from the light combining element 500. The projection optical system 550 enlarges and displays images input to a blue light modulation element 581, a green light modulation element 582, and a red light modulation element 583 on a screen SCR.

The light source holding member 300 is a member for holding the unitized green light source module 500G, blue light source module 500B, and red light source module 500R.

The green image forming module 510, the blue image forming module 520, and the red image forming module 530 have the same configuration except for the corresponding colors of light.

First, the green image forming module 510 will be described as an example. The green light source module 500G of the green image forming module 510 includes a green light source 512, a green light guide element 542, and a green parallelizing element (optical element) 562.

The green light source 512 has a green light emitting element 512a and a substrate 512b on which the green light emitting element 512a is mounted.

The substrate 512b has the green light emitting element 512a. The green light emitting element 512a emits a green light LG. In the following description, a direction parallel to the optical axis of the green light LG emitted from the green light emitting element 512a is the Z direction (optical axis direction). One side in the Z direction is referred to as a -Z side, and the opposite side to the -Z side in the Z direction is referred to as the +Z side. A direction orthogonal to the Z direction within a plane including the optical axis of the green light LG is an X direction. One side in the X direction is referred to as a -X side, and the opposite side to the -X side in the X direction is referred to as a +X side. A direction orthogonal to the Z direction and the X direction is a Y direction. The green light LG emitted from the green light emitting element 512a travels to the +Z side along the Z direction.

The green light emitting element 512a is supported by the substrate 512b. The substrate 512b is a plate parallel to a plane including the X direction and the Y direction.

The green light emitting element 512a is provided on the plate surface at the +Z side in the substrate 512b. The light emitting surface of the green light emitting element 512a is a surface at the +Z side. The green light emitting element 512a emits the green light LG in a green wavelength band in the visible wavelength band. The green light LG is emitted to the +Z side with an axis passing through the center of the light emitting surface of the green light emitting element 512a and being parallel to the Z direction as a center. The green wavelength band is, for example, a wavelength band ranging from 500 nm to 600 nm. Since the green wavelength band is easy for the human eyes to recognize, a large amount of light is required for projection onto a screen SCR.

The green light guide element 542 is provided in the optical path of the green light LG emitted from the green light emitting element 512a, and is disposed at the +Z side of the green light emitting element 512a.

The green parallelizing element 562 is provided in the optical path of the green light LG emitted from the green light guide element 542. The green parallelizing element 562 parallelizes the green light LG emitted from the green light guide element 542 along the Z direction.

The green light modulation device 505 includes the green light incident-side polarization element 572, the green light modulation element 582, and the green light exiting-side polarization element 576. The green light modulation device 505 is provided in the optical path of the green light LG emitted from the green parallelizing element 562.

The green light incident-side polarization element 572 is disposed at the +Z side of the green parallelizing element 562. The green light incident-side polarization element 572 emits predetermined polarized light of the green light LG emitted from the green parallelizing element 562 to the +Z side along the Z direction. The green light incident-side polarization element 572 is, for example, a reflective or absorptive polarizer.

The green light modulation element 582 is disposed at the +Z side of the green light incident-side polarization element 572. The green light modulation element 582 modulates the green light LG emitted from the green light incident-side polarization element 572. The green light modulation element 582 is, for example, a transmissive liquid crystal panel. The liquid crystal panel forming the green light modulation element 582 generates a green image light IG by modulating the light based on green image information. The green light modulation element 582 emits the generated image light IG to the +Z side along the Z direction.

The green light exiting-side polarization element 576 is disposed at the +Z side of the green light modulation element 582. The green light exiting-side polarization element 576 emits predetermined polarized light of the image light IG emitted from the green light modulation element 582 to the +Z side along the Z direction. The green light exiting-side polarization element 576 is, for example, a reflective or absorptive polarizer.

Next, the structure of the green light source module 500G will be described in more detail.

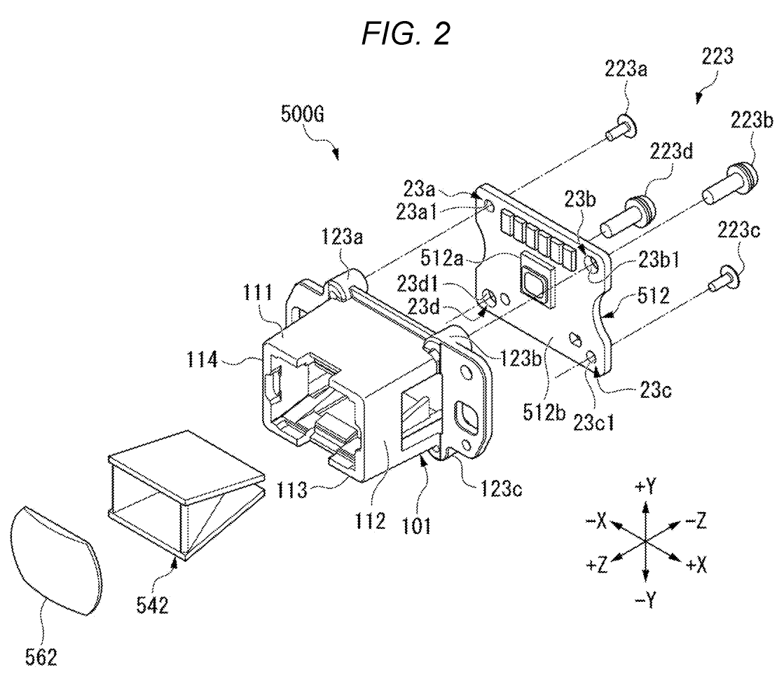

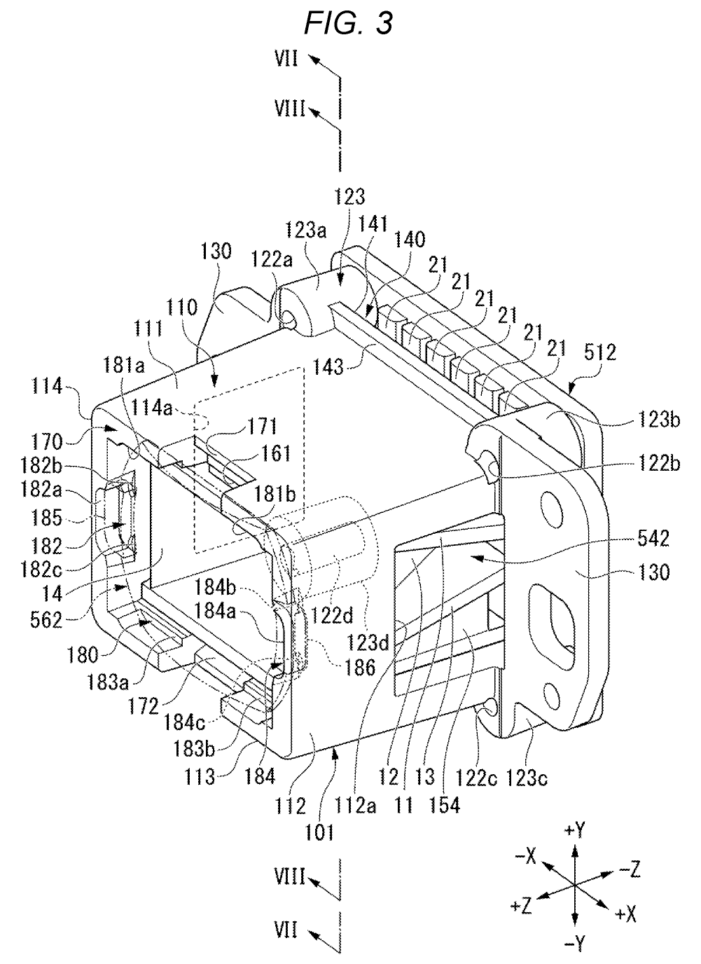

FIG. 2 is an exploded perspective view of the green light source module. FIG. 3 is a perspective view showing an overall configuration of the green light source module. As illustrated in FIGS. 2 and 3, the green light source module 500G includes the green light source 512, a holding member 101, the green light guide element 542, and the green parallelizing element 562.

The green light source module 500G is configured by disposing the green light source 512, the holding member 101, and the green parallelizing element 562 in this order from the -Z side to the +Z side. The green light guide element 542 is held inside the holding member 101.

The substrate 512b of the green light source 512 is a rectangular plate having a longitudinal direction along the X direction and a lateral direction along the Y direction. The substrate 512b has a thickness in the Z direction.

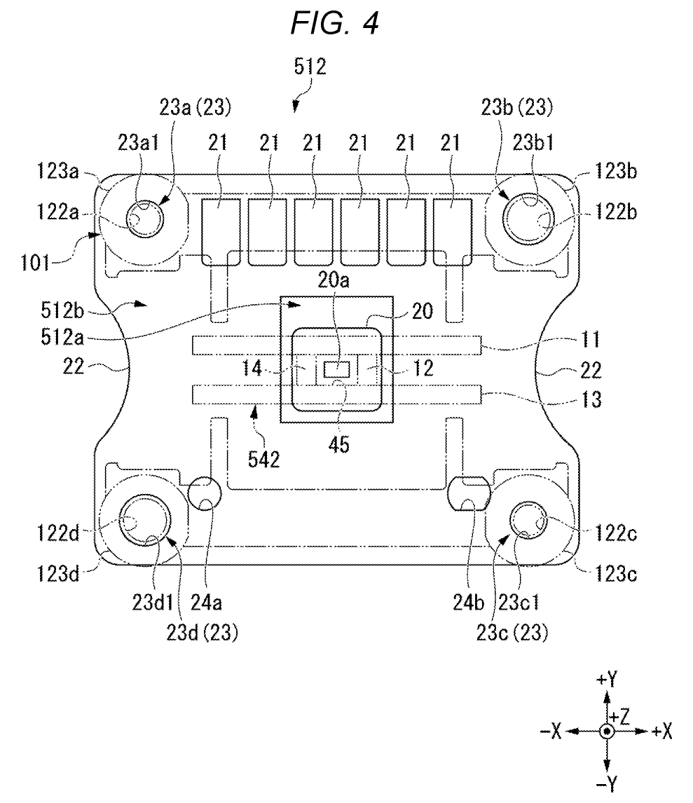

FIG. 4 is a plan view of the green light source 512. As illustrated in FIG. 4, the substrate 512b of the green light source 512 has the green light emitting element 512a mounted thereon, and has structures 21, recesses 22, a plurality of receiving portions 23, and positioning holes 24a and 24b. The green light emitting element 512a is provided at the center of the plate surface at the +Z side in the substrate 512b. The green light emitting element 512a has a thickness in the Z direction. The green light emitting element 512a is a rectangular LED chip, and has a light emitting unit 20 in the lower part at the center. The light emitting unit 20 has a rectangular shape and has a light emitting region 20a. The light emitting region 20a emits the green light LG toward the +Z side along the Z direction.

The structure 21 is an electronic component or a solder pad including a drive circuit for driving the green light emitting element 512a. The structure 21 is provided at the +Y side of the plate surface at the +Z side in the substrate 512b. A plurality of the structures 21 are disposed along the longitudinal direction of the substrate 512b at the +Y side, and, for example, six structures are disposed in the case of the present embodiment. The structure 21 has a rectangular shape having a longitudinal direction along the Y direction and a lateral direction along the X direction. The structure 21 has a thickness in the Z direction. The arrangement of the structures 21 on the substrate 512b and the number of the structures 21 may be appropriately changed.

The recess 22 is formed on each side of the substrate 512b in the lateral direction. The recesses 22 each have a semicircular shape recessed toward the center of the substrate 512b.

The plurality of receiving portions 23 are regions provided on the surface of the substrate 512b at the four corner sides and coming into contact with a plurality of coupling portions 123 of the holding member 101, which will be described later. The plurality of receiving portions 23 include a first receiving portion 23a, a second receiving portion 23b, a third receiving portion 23c, and a fourth receiving portion 23d.

The first receiving portion 23a and the second receiving portion 23b are provided at the +Y side of the substrate 512b. The first receiving portion 23a and the second receiving portion 23b are arranged in order in the +X direction. The third receiving portion 23c and the fourth receiving portion 23d are provided at the -Y side of the substrate 512b. The third receiving portion 23c and the fourth receiving portion 23d are arranged in order in the -X direction. The structures 21 are disposed between the first receiving portion 23a and the second receiving portion 23b. As described above, the plurality of receiving portions 23 are disposed on the substrate 512b so as to surround the green light emitting element 512a.

Each of the plurality of receiving portions 23 has a circular through hole penetrating in the Z direction. More specifically, the first receiving portion 23a has a first through hole 23a1. The second receiving portion 23b has a second through hole 23b1. The third receiving portion 23c has a third through hole 23c1. The fourth receiving portion 23d has a fourth through hole 23d1. The plurality of receiving portions 23 are coupled to the plurality of coupling portions 123 of the holding member 101 described later via a plurality of fixing members 223.

As described above, the plurality of receiving portions 23 are formed at the four corner sides in the substrate 512b. According to the configuration, the green light emitting element 512a can be disposed at the center of the substrate 512b. Therefore, the green light emitting element 512a can be stably provided on the substrate 512b.

The structures 21 and the plurality of receiving portions 23 are provided at intervals from the green light emitting element 512a. Therefore, these components are less likely to be affected by light, heat, and the like from the green light emitting element 512a that emits the green light LG. Accordingly, deterioration of the component can be suppressed.

The positioning holes 24a and 24b are provided at the -Y side of the substrate 512b. The positioning holes 24a and 24b are holes penetrating in the Z direction. The positioning hole 24a is formed at the +X side and the +Y side of the fourth receiving portion 23d. The positioning hole 24b is formed at the -X side and the +Y side of the third receiving portion 23c. The positioning hole 24a is a circular hole penetrating in the Z direction. The positioning hole 24b has a linear edge along the X direction and an arc-shaped edge along the Y direction. The positioning hole 24b has a larger hole diameter in the X direction than the positioning hole 24a. Positioning pins 224a and 224b of the holding member 101 described later are inserted into the positioning holes 24a and 24b.

As illustrated in FIGS. 2 and 3, the holding member 101 has a box shape with both ends in the Z direction open. First, the outside of the holding member 101 will be described. The holding member 101 includes a wall portion 110, an incident end portion 140, the plurality of coupling portions 123, an attachment portion 130, and an emission end portion 170.

The wall portion 110 forms a side surface of the holding member 101 along the X direction and the Y direction. The wall portion 110 includes a first side surface portion 111, a second side surface portion 112, a third side surface portion 113, and a fourth side surface portion 114.

The first side surface portion 111 and the third side surface portion 113 are side surfaces parallel to a plane including the X direction and the Z direction. The first side surface portion 111 and the third side surface portion 113 are located in order in the -Y direction.

The second side surface portion 112 and the fourth side surface portion 114 are side surfaces parallel to a plane including the Y direction and the Z direction. The second side surface portion 112 and the fourth side surface portion 114 are located in order in the -X direction.

The end of the first side surface portion 111 along the Z direction at the +X side is coupled to the end of the second side surface portion 112 along the Z direction at the +Y side. The end of the second side surface portion 112 along the Z direction at the -Y side is coupled to the end of the third side surface portion 113 along the Z direction at the +X side. The end of the third side surface portion 113 along the Z direction at the -X side is coupled to the end of the fourth side surface portion 114 along the Z direction at the -Y side. The end of the fourth side surface portion 114 along the Z direction at the +Y side is coupled to the end of the first side surface portion 111 along the Z direction at the -X side.

The coupling portions of the respective side surface portions 111, 112, 113, and 114 are rounded and integrated. The ends of the first side surface portion 111, the second side surface portion 112, the third side surface portion 113, and the fourth side surface portion 114 along the Z direction are respectively coupled to form the shape of the wall portion 110.

An opening portion 112a is formed in the second side surface portion 112. The opening portion 112a is formed from the center of the second side surface portion 112 to the -Z side. The opening portion 112a is a rectangular opening penetrating in the X direction.

The end of the opening portion 112a at the -Z side overlaps the end of the second side surface portion 112 at the -Z side when viewed from the X direction. Accordingly, a part of the end at the -Z side in the second side surface portion 112 is formed to be interrupted by the opening portion 112a. The end of the opening portion 112a at the +Z side is formed along the Y direction substantially at the center of the second side surface portion 112. The end at the -Z side and the end at the +Z side in the opening portion 112a are formed substantially parallel to each other.

The end of the opening portion 112a at the +Y side is formed along the Z direction in the vicinity of the coupling portion between the first side surface portion 111 and the second side surface portion 112. The end of the opening portion 112a at the -Y side is formed along the Z direction in the vicinity of the coupling portion between the second side surface portion 112 and the third side surface portion 113.

An opening portion 114a is formed in the fourth side surface portion 114. The opening portion 114a is formed from the center of the fourth side surface portion 114 to the -Z side. The opening portion 114a is a rectangular opening penetrating in the X direction.

The end of the opening portion 114a at the -Z side overlaps the end of the fourth side surface portion 114 at the -Z side when viewed from the X direction. Accordingly, a part of the end of the fourth side surface portion 114 at the -Z side is formed to be interrupted by the opening portion 114a. The end of the opening portion 114a at the +Z side is formed along the Y direction substantially at the center of the fourth side surface portion 114. The end at the -Z side and the end at the +Z side of the opening portion 114a are formed substantially parallel to each other.

The end of the opening portion 114a at the +Y side is formed along the Z direction in the vicinity of the coupling portion between the first side surface portion 111 and the fourth side surface portion 114. The end of the opening portion 114a at the -Y side is formed along the Z direction in the vicinity of the coupling portion between the fourth side surface portion 114 and the third side surface portion 113.

The opening portion 112a and the opening portion 114a overlap the incident end side of the green light guide element 542 held inside the holding member 101 when viewed from the X direction. The shape of the green light guide element 542 will be described in detail later.

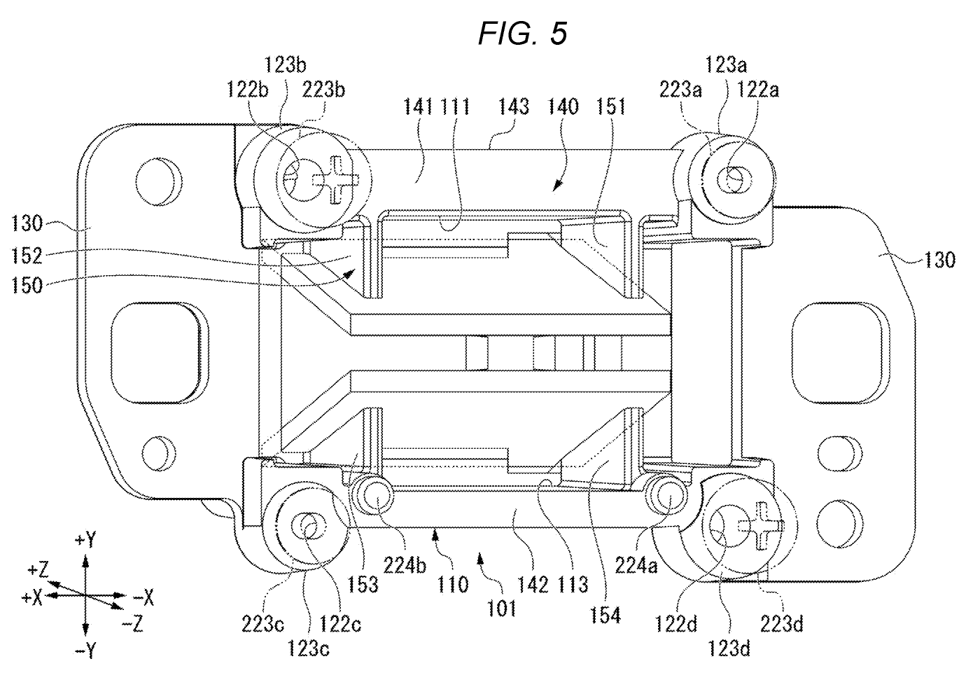

FIG. 5 is a perspective view of the green light source module 500G with the green light source 512 removed. As illustrated in FIGS. 2, 3, and 5, the plurality of coupling portions 123 are formed at four vertices at the -Z side of the wall portion 110. The plurality of coupling portions 123 have hollow cylindrical shapes as a whole and have holes penetrating in the Z direction. The plurality of coupling portions 123 have cylindrical shapes having the Z direction as an axial direction and the X direction and the Y direction as radial directions. The plurality of coupling portions 123 are provided to face the substrate 512b. The plurality of coupling portions 123 include a first coupling portion 123a, a second coupling portion 123b, a third coupling portion 123c, and a fourth coupling portion 123d.

The first coupling portion 123a and the second coupling portion 123b are provided at the +Y side of the wall portion 110. The first coupling portion 123a and the second coupling portion 123b are arranged in order in the -X direction. The third coupling portion 123c and the fourth coupling portion 123d are provided at the -Y side of the wall portion 110. The third coupling portion 123c and the fourth coupling portion 123d are arranged in order in the +X direction. As described above, the plurality of coupling portions 123 are disposed so as to surround the green light emitting element 512a.

A first hole portion 122a is formed in the first coupling portion 123a. The first hole portion 122a is a circular hole penetrating in the Z direction. A screw thread is formed in the first hole portion 122a.

A third hole portion 122c is formed in the third coupling portion 123c. The third hole portion 122c is a circular hole penetrating in the Z direction. A screw thread is formed in the third hole portion 122c.

The first coupling portion 123a and the third coupling portion 123c have the same shape. The first hole portion 122a and the third hole portion 122c have the same shape.

A second hole portion 122b is formed in the second coupling portion 123b. The second hole portion 122b is a circular hole penetrating in the Z direction. A screw thread is formed in the second hole portion 122b.

A fourth hole portion 122d is formed in the fourth coupling portion 123d. The fourth hole portion 122d is a circular hole penetrating in the Z direction. A screw thread is formed in the fourth hole portion 122d.

The second coupling portion 123b and the fourth coupling portion 123d have the same shape. The second hole portion 122b and the fourth hole portion 122d have the same shape.

The first coupling portion 123a and the third coupling portion 123c have smaller outer diameters than the second coupling portion 123b and the fourth coupling portion 123d.

The first hole portion 122a and the third hole portion 122c have smaller inner diameters than the second hole portion 122b and the fourth hole portion 122d.

The plurality of coupling portions 123 and the plurality of receiving portions 23 are coupled to each other via the plurality of fixing members 223. The plurality of fixing members 223 are fasteners such as screws or bolts inserted through the through holes of the plurality of coupling portions 123 and the plurality of receiving portions 23. The plurality of fixing members 223 include a first fixing member 223a, a second fixing member 223b, a third fixing member 223c, and a fourth fixing member 223d. The first fixing member 223a and the third fixing member 223c have the same shape. The second fixing member 223b and the fourth fixing member 223d have the same shape.

Here, a method of fixing the substrate 512b and the holding member 101 is described.

The first fixing member 223a is inserted through the first through hole 23a1 of the first receiving portion 23a, and inserted into the first hole portion 122a of the first coupling portion 123a. The second fixing member 223b is inserted through the second through hole 23b1 of the second receiving portion 23b, and inserted into the second hole portion 122b of the second coupling portion 123b. The third fixing member 223c is inserted through the third through hole 23c1 of the third receiving portion 23c, and inserted into the third hole portion 122c of the third coupling portion 123c. The fourth fixing member 223d is inserted through the fourth through hole 23d1 of the fourth receiving portion 23d, and inserted into the fourth hole portion 122d of the fourth coupling portion 123d. As a result, the plurality of coupling portions 123 and the plurality of receiving portions 23 come into contact with each other, and the plurality of coupling portions 123 and the plurality of receiving portions 23 are coupled to each other via the plurality of fixing members 223. Therefore, the substrate 512b is directly fixed to the holding member 101.

According to the configuration, the plurality of coupling portions 123 and the plurality of receiving portions 23 are arranged at equal intervals from the green light emitting element 512a. Therefore, the green light emitting element 512a can be stably supported. Thus, the substrate 512b and the holding member 101 can be stably fixed.

As illustrated in FIG. 5, the inner diameters of the first receiving portion 23a and the third receiving portion 23c in the substrate 512b are formed to be larger than the inner diameters of the first hole portion 122a and the third hole portion 122c in the holding member 101. The inner diameters of the second receiving portion 23b and the fourth receiving portion 23d in the substrate 512b are formed to be larger than the inner diameters of the second hole portion 122b and the fourth hole portion 122d in the holding member 101. Accordingly, when the fixing members 223a, 223b, 223c, and 223d are inserted, the substrate 512b can be fixed to the holding member 101 while the position of the substrate in the X direction and the Y direction is adjusted.

The incident end portion 140 is provided at the -Z side facing the substrate 512b in the wall portion 110. The incident end portion 140 forms an end of the wall portion 110 at the -Z side.

As illustrated in FIG. 5, the incident end portion 140 includes a first incident end portion 141 and a second incident end portion 142. The first incident end portion 141 is provided continuously between the first coupling portion 123a and the second coupling portion 123b.

The first incident end portion 141 extends along the X direction. The end of the first incident end portion 141 at the -X side is coupled to the first coupling portion 123a. The end of the first incident end portion 141 at the +X side is coupled to the second coupling portion 123b. The first incident end portion 141 is provided at the +Z side of the ends at the -Z side of the first coupling portion 123a and the second coupling portion 123b.

As illustrated in FIG. 3, the first incident end portion 141 is provided via a predetermined space between the substrate 512b and itself. The predetermined space is wide enough to avoid an interference between the structures 21 having the thickness to the +Z side from the substrate 512b and the first incident end portion 141. Depending on the arrangement of the structures 21, the first incident end portion 141 and the substrate 512b are not necessarily provided via a predetermined space.

The first incident end portion 141 has a flange portion 143. The flange portion 143 protrudes from the wall portion 110 to the +Y side and extends along the X direction when viewed from the Z direction. The flange portion 143 is formed integrally with the first incident end portion 141. The end of the flange portion 143 at the +Y side is located at the -Y side of the ends of the first coupling portion 123a and the second coupling portion 123b at the +Y side.

The flange portion 143 is provided continuously between the first coupling portion 123a and the second coupling portion 123b. Accordingly, the coupling strength between the first coupling portion 123a and the second coupling portion 123b formed at the four vertices of the wall portion 110 and the wall portion 110 can be increased. In addition, it is possible to prevent dust, dirt, or the like from entering from the predetermined space between the first incident end portion 141 and the substrate 512b.

As illustrated in FIG. 5, the second incident end portion 142 is provided continuously between the third coupling portion 123c and the fourth coupling portion 123d. The second incident end portion 142 extends along the X direction. The end of the second incident end portion 142 at the +X side is coupled to the third coupling portion 123c. The end of the second incident end portion 142 at the -X side is coupled to the fourth coupling portion 123d. The second incident end portion 142 is provided at the same position as those of the ends at the -Z side of the third coupling portion 123c and the fourth coupling portion 123d in the Z direction.

The second incident end portion 142 includes the positioning pins 224a and 224b. The positioning pins 224a and 224b function as guides for positioning when the holding member 101 and the substrate 512b are fixed. The positioning pins 224a and 224b protrude from the second incident end portion 142 toward the -Z side.

The positioning pin 224a is formed at the +X side and the +Y side of the fourth receiving portion 23d. The positioning pin 224b is formed at the -X side and the +Y side of the third receiving portion 23c. The positioning pin 224a is provided at a position corresponding to the positioning hole 24a. The positioning pin 224b is provided at a position corresponding to the positioning hole 24b. The positioning pin 224a and the positioning pin 224b have the same diameter. The positioning pins 224a and 224b are inserted into the positioning holes 24a and 24b.

The attachment portion 130 is a plate-shaped member protruding toward the X direction from the ends at the +Z side of the first coupling portion 123a and the third coupling portion 123c and the ends at the +Z side of the second coupling portion 123b and the fourth coupling portion 123d. The attachment portion 130 is a member for attaching the unitized green light source module 500G, blue light source module 500B, and red light source module 500R to the light source holding member 300 illustrated in FIG. 1.

As illustrated in FIG. 3, the emission end portion 170 forms the end of the wall portion 110 at the +Z side. The details of the emission end portion 170 will be described later.

Next, the configuration of the green light guide element 542 is described.

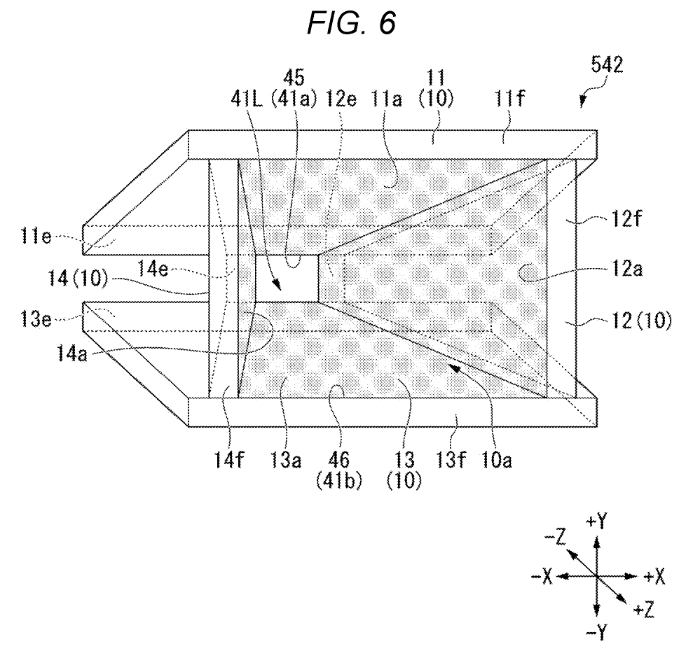

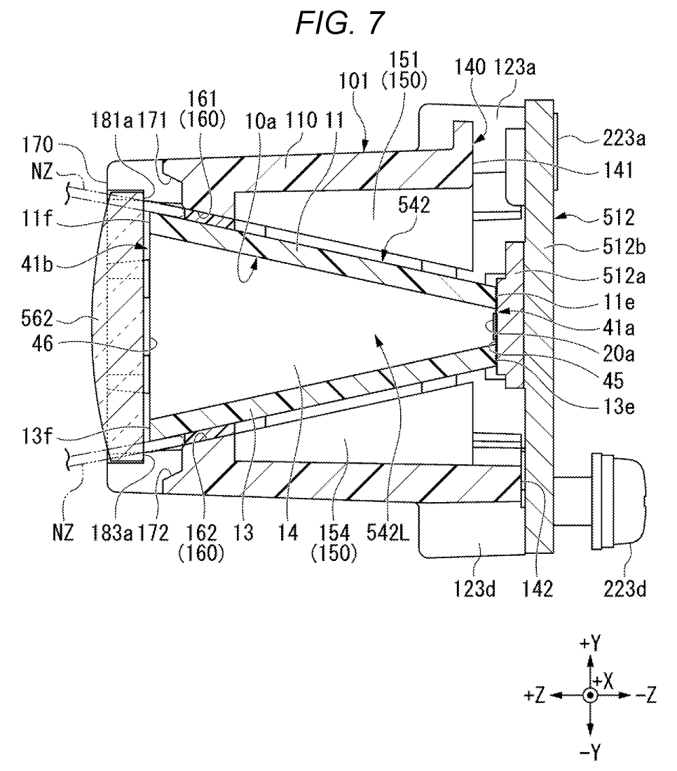

FIG. 6 is a perspective view of the green light guide element 542. FIG. 7 is a cross-sectional view taken along line VII in FIG. 3. As illustrated in FIGS. 6 and 7, the green light guide element 542 defines the light guide path that guides the green light LG emitted from the light emitting region 20a, and propagates the green light LG to the green parallelizing element 562. The green light guide element 542 includes a plurality of plate members 10. The plurality of plate members 10 include a first member 11, a second member 12, a third member 13, and a fourth member 14.

The first member 11 and the third member 13 are a pair of rectangular plate members. The first member 11 has a first reflection surface 11a on one planar surface. The third member 13 has a third reflection surface 13a on one planar surface. The first member 11 and the third member 13 are plate members having the same shape.

The second member 12 and the fourth member 14 are a pair of trapezoidal plate members. The second member 12 has a second reflection surface 12a on one planar surface. The fourth member 14 has a fourth reflection surface 14a on one planar surface. The second member 12 and the fourth member 14 are plate members having the same shape. In the following description, when the first reflection surface 11a, the second reflection surface 12a, the third reflection surface 13a, and the fourth reflection surface 14a are not particularly distinguished from one another, these may be collectively referred to as reflection surfaces 10a. The reflective surface 10a forms a light guide path 542L that guides the green light LG to the inside of the green light guide element 542.

The first reflection surface 11a of the first member 11 and the third reflection surface 13a of the third member 13 are disposed to face each other. The second reflection surface 12a of the second member 12 and the fourth reflection surface 14a of the fourth member 14 are disposed to face each other. The second member 12 and the fourth member 14 are each so disposed that the upper base thereof is located at the -Z side and the lower base thereof is located at the +Z side.

One side surface that is an oblique side portion of each of the trapezoidal second member 12 and fourth member 14 is coupled to the first reflection surface 11a of the first member 11. The other side surface that is another oblique side portion of each of the second member 12 and fourth member 14 is coupled to the third reflection surface 13a of the third member 13. The plurality of plate members 10 are bonded by an adhesive. Accordingly, the plurality of plate members 10 form the shape of the green light guide element 542.

The first member 11 has a first incident end surface 11e at the -Z side end. The second member 12 has a second incident end surface 12e at the -Z side end. The third member 13 has a third incident end surface 13e at the -Z side end. The fourth member 14 has a fourth incident end surface 14e at the -Z side end. A part of the first incident end surface 11e, the second incident end surface 12e, a part of the third incident end surface 13e, and the fourth incident end surface 14e form an incident opening 45. The incident opening 45 forms an incident end 41a at the -Z side in the light guide path 542L.

The first member 11 has a first emission end surface 11f at the +Z side end. The second member 12 has a second emission end surface 12f at the +Z side end. The third member 13 has a third emission end surface 13f at the +Z side end. The fourth member 14 has a fourth emission end surface 14f at the +Z side end. The first emission end surface 11f, the second emission end surface 12f, the third emission end surface 13f, and the fourth emission end surface 14f form an emission opening 46. The emission opening 46 forms an emission end 41b at the +Z side in the light guide path 542L.

The incident opening 45 spreads in parallel to the plane including the X direction and the Y direction. The incident opening 45 has a rectangular shape when viewed from the Z direction. The size of the incident opening 45 may be equal to the size of the light emitting region 20a, but is preferably appropriately larger than the size of the light emitting region 20a.

The emission opening 46 spreads in parallel to the plane including the X direction and the Y direction. The emission opening 46 is larger than the incident opening 45. The emission opening 46 has a rectangular shape when viewed from the Z direction.

According to the configuration, it is possible to increase the luminous flux width in the process of propagating the green light LG incident from the incident opening 45 within the light guide path 542L. Accordingly, it is possible to generate the green light LG having a uniform illuminance distribution for efficiently illuminating the entire green light modulation element 582.

As illustrated in FIG. 7, the first incident end surface 11e and the third incident end surface 13e are parallel to a plane including the X direction and the Y direction. When normal plate members are bonded as they are, the corner portions of the first incident end surface 11e and the third incident end surface 13e in the first member 11 and the third member 13 protrude to the -X side. The corner portions of the first incident end surface 11e and the third incident end surface 13e may be cut off so as to be parallel to the plane including the X direction and the Y direction. Similarly, the second incident end surface 12e and the fourth incident end surface 14e are parallel to the plane including the X direction and the Y direction.

According to the configuration, the gap between the incident opening 45 and the light emitting region 20a in the X direction can be reduced. Accordingly, the incident opening 45 and the light emitting region 20a can be disposed close to each other in the X direction. Therefore, it is possible to suppress the amount of leakage light generated from the light emitting region 20a toward the incident opening 45 of the green light guide element 542.

The first emission end surface 11f and the third emission end surface 13f are parallel to a plane including the X direction and the Y direction. The corner portions of the first emission end surface 11f and the third emission end surface 13f are cut off so as to be parallel to the plane including the X direction and the Y direction.

According to the configuration, the gap between the emission opening 46 and the green light modulation element 582 can be reduced. Accordingly, the emission opening 46 and the green light modulation element 582 can be disposed close to each other. Therefore, it is possible to suppress the amount of the leakage light generated from the emission opening 46 of the green light guide element 542 toward the green light modulation element 582.

As illustrated in FIGS. 6 and 7, the green light guide element 542 has the incident end 41a and the emission end 41b. The incident end 41a is located at the -Z side in the Z direction. The emission end 41b is located at the +Z side in the Z direction.

The green light LG emitted from the light emitting region 20a in the green light emitting element 512a is incident on the light guide path 542L of the green light guide element 542 from the incident end 41a. In the green light guide element 542, the space surrounded by the incident opening 45, the emission opening 46, and the reflection surfaces 10a serves as the light guide path 542L, through which the green light LG propagates. Thus, the green light LG incident on the green light guide element 542 propagates through the light guide path 542L from the -Z side to the +Z side.

Part of the green light LG incident on the green light guide element 542 propagates directly from the incident end 41a to the emission end 41b, without being incident on the reflection surfaces 10a even once, along directions at angles smaller than the inclination angles of the trapezoidal oblique sides of the second member 12 and the fourth member 14. The remaining part of the green light LG incident on the green light guide element 542 is incident on the reflection surfaces 10a from the incident end 41a at angles equal to or larger than the angles described above at one or more times, is reflected by the reflection surfaces 10a, and then reaches the emission end 41b. The paths of beams of the green light LG in the region surrounded by the incident end 41a, the emission end 41b, and the reflection surfaces 10a vary in accordance with the incident angles on the incident end 41a, and are a plurality of paths in which the numbers of times of reflections by the reflection surfaces 10a are different from one another. Therefore, the illuminance distribution of the green light LG that propagates through the region surrounded by the incident end 41a, the emission end 41b, and the reflection surfaces 10a is uniformized in a plane including the X direction and the Y direction. That is, the green light guide element 542 uniformizes the illuminance distribution of the incident green light LG in the plane including the X direction and the Y direction. The green light LG having the uniformized illuminance distribution is emitted from the emission end 41b toward the +Z side.

As illustrated in FIG. 3, the opening portion 112a is provided to face the ends of the first member 11 and the third member 13 at the incident end side in the green light guide element 542 when viewed from the +X side. The opening portion 114a is provided to face the ends of the first member 11 and the third member 13 at the incident end side in the green light guide element 542 when viewed from the -X side.

According to the configuration, when the green light guide element 542 is bonded and fixed to the holding member 101, it is possible to finely adjust the position of the green light guide element 542 from the opening portions 112a and 114a using a jig or the like after inserting the green light guide element 542 into the holding member 101.

As illustrated in FIG. 4, the incident opening 45 of the green light guide element 542 is provided to face the green light emitting element 512a of the substrate 512b. The light emitting region 20a is surrounded by a part of the first incident end surface 11e, the second incident end surface 12e, a part of the third incident end surface 13e, and the fourth incident end surface 14e. Thus, the green light LG emitted from the light emitting region 20a is guided into the green light guide element 542.

Next, the internal configuration of the holding member 101 will be described. As illustrated in FIGS. 5 and 7, the holding member 101 has a guide portion 150 and an adhesive surface 160.

The guide portion 150 is a triangular plate-shaped member protruding into the wall portion 110. The guide portion 150 is formed integrally with the holding member 101. The guide portion 150 includes a first guide portion 151, a second guide portion 152, a third guide portion 153, and a fourth guide portion 154. The first guide portion 151, the second guide portion 152, the third guide portion 153, and the fourth guide portion 154 have the same shape.

The first guide portion 151 is provided at the -X side of the first side surface portion 111. The first guide portion 151 extends along the Z direction inside the wall portion 110. The first guide portion 151 protrudes to the -Y side. The end at the +Y side of the first guide portion 151 is disposed along the surface of the first member 11 of the green light guide element 542. The protrusion amount of the first guide portion 151 at the incident end portion 140 side is larger than the protrusion amount at the emission end portion 170 side. The incident end portion 140 side corresponds to the -Z side, and the emission end portion 170 side corresponds to the +Z side. The protrusion amount of the first guide portion 151 continuously decreases from the -Z side toward the +Z side. That is, the first guide portion 151 is formed along the shape of the green light guide element 542.

The end of the first guide portion 151 at the -Z side extends toward the -Y side from a plane including the X direction and the Y direction in the first incident end portion 141. The first guide portion 151 is provided at a predetermined interval from the first member 11.

The second guide portion 152 is provided at the +X side of the first side surface portion 111. The second guide portion 152 extends along the Z direction inside the wall portion 110. The second guide portion 152 protrudes to the -Y side. The end at the +Y side of the second guide portion 152 is disposed along the surface of the first member 11 of the green light guide element 542. The protrusion amount of the second guide portion 152 at the incident end portion 140 side is larger than the protrusion amount at the emission end portion 170 side.

The end of the second guide portion 152 at the -Z side extends toward the -Y side from a plane including the X direction and the Y direction in the first incident end portion 141. The ends of the first guide portion 151 and the second guide portion 152 at the -Z side are provided at the same position in a plane including the X direction and the Y direction. The second guide portion 152 is provided at a predetermined interval from the first member 11.

The third guide portion 153 is provided at the -X side of the third side surface portion 113. The third guide portion 153 extends along the Z direction inside the wall portion 110. The third guide portion 153 protrudes to the +Y side. The end of the third guide portion 153 at the -Y side is disposed along the surface of the third member 13 of the green light guide element 542. The protrusion amount of the third guide portion 153 at the incident end portion 140 side is larger than the protrusion amount at the emission end portion 170 side.

The end of the third guide portion 153 at the -Z side is provided at the same position as those of the ends of the first guide portion 151 and the second guide portion 152 at the -Z side in a plane including the X direction and the Y direction. The end of the third guide portion 153 at the -Z side extends toward the +Y side. The third guide portion 153 is provided at a predetermined interval from the first member 11.

The fourth guide portion 154 is provided at the +X side of the third side surface portion 113. The fourth guide portion 154 extends along the Z direction inside the wall portion 110. The fourth guide portion 154 protrudes to the +Y side. The end of the fourth guide portion 154 at the -Y side is disposed along the surface of the third member 13 of the green light guide element 542. The protrusion amount of the fourth guide portion 154 at the incident end portion 140 side is larger than the protrusion amount at the emission end portion 170 side.

The end of the fourth guide portion 154 at the -Z side is provided at the same position as those of the ends of the first guide portion 151, the second guide portion 152, and the third guide portion 153 at the -Z side in a plane including the X direction and the Y direction. The end of the fourth guide portion 154 at the -Z side extends toward the +Y side. The fourth guide portion 154 is provided at a predetermined interval from the third member 13.

According to the configuration, the first guide portion 151, the second guide portion 152, the third guide portion 153, and the fourth guide portion 154 are formed along the shape of the green light guide element 542. Therefore, when the green light guide element 542 is disposed inside the holding member 101, the position of the green light guide element 542 can be guided.

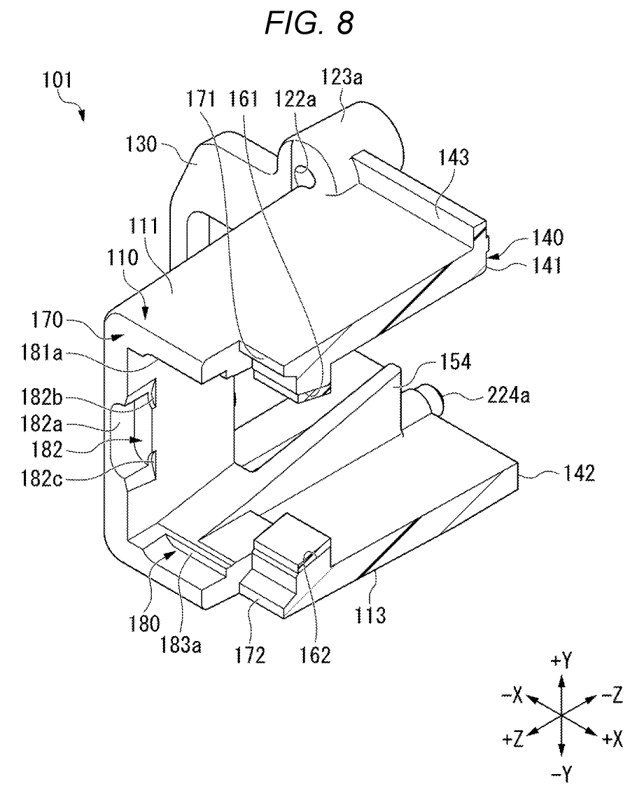

FIG. 8 is a cross-sectional perspective view of the holding member. As illustrated in FIGS. 7 and 8, the adhesive surface 160 is a surface for fixing the green light guide element 542 to the holding member 101 with an adhesive. The adhesive surface 160 is provided at the +Z side of the holding member 101, that is, at the emission end portion 170 side. The adhesive surface 160 is formed integrally with the holding member 101. The adhesive surface 160 has a first adhesive surface portion 161 and a second adhesive surface portion 162.

The first adhesive surface portion 161 is provided at the center at the +Z side of the first side surface portion 111. The first adhesive surface portion 161 is a rectangular plate having a longitudinal direction along the X direction and a lateral direction along the Z direction. The first adhesive surface portion 161 protrudes from the inside of the first side surface portion 111 to the -Y side and has a thickness. The first adhesive surface portion 161 is disposed along the surface of the first member 11 of the green light guide element 542. The first adhesive surface portion 161 has the same inclination as the first guide portion 151 and the second guide portion 152. A gap to which an adhesive is applied is formed between the first adhesive surface portion 161 and the first member 11.

The second adhesive surface portion 162 is provided at the center at the +Z side of the third side surface portion 113. The second adhesive surface portion 162 is a rectangular plate having a longitudinal direction along the X direction and a lateral direction along the Z direction. The second adhesive surface portion 162 protrudes from the inside of the third side surface portion 113 to the +Y side and has a thickness. The second adhesive surface portion 162 is disposed along the surface of the third member 13 of the green light guide element 542. The second adhesive surface portion 162 has the same inclination as the third guide portion 153 and the fourth guide portion 154. A gap to which an adhesive is applied is formed between the second adhesive surface portion 162 and the third member 13.

A nozzle Nz for injecting an adhesive is inserted into the gaps formed between the first adhesive surface portion 161 and the first member 11 and between the second adhesive surface portion 162 and the third member 13. As illustrated in FIG. 7, the nozzle Nz is inserted along the surfaces of the first member 11 and the third member 13 in the green light guide element 542, and applies the adhesive to the adhesive surface 160.

According to the configuration, it is not necessary to provide a new component for fixing the green light guide element 542 to the holding member 101, and the number of components can be reduced. Since it is necessary to provide only the gaps for applying the adhesive, the holding member 101 can be reduced in size.

The gaps are formed between the adhesive surface 160 and the green light guide element 542. Accordingly, the adhesive can be applied after the green light guide element 542 is positioned to be fixed inside the holding member 101. Therefore, the position adjustment of the green light guide element 542 is easier inside the holding member 101.

In the present embodiment, the guide portion 150 and the adhesive surface 160 are formed separately, but may be integrally formed.

Here, the leakage light is described. The leakage light is a light emitted from the light emitting unit 20 along a direction at an angle larger than the taper angle of the trapezoids in the second member 12 and the fourth member 14. The leakage light contains various angular components, and the leakage light emitted along a direction at an angle slightly larger than the taper angle of the trapezoids in the second member 12 and the fourth member 14 is likely to enter the side surface of the green light guide element 542 at the incident end 41a side.

In contrast, in order that the leakage light reaches the side surface of the green light guide element 542 at the emission end 41b side, it is necessary that the leakage light emitted in the direction at an angle equivalent to the taper angle of the trapezoids in the second member 12 and the fourth member 14 travels along the outer surface of the green light guide element 542 from the incident end 41a side to the emission end 41b side. Accordingly, the amount of light reaching the emission end 41b side of the leakage light is sufficiently smaller than the amount of light incident on the incident end 41a side.

Therefore, when the adhesive for fixing the green light guide element 542 to the holding member 101 is provided at the incident end 41a side, the adhesive is likely to deteriorate due to an increase in the irradiation amount of the leakage light.

According to the configuration, the adhesive surface 160 is provided at the emission end portion 170 side of the holding member 101. Accordingly, in comparison with a case where the adhesive surface 160 is provided at the incident end portion 140 side closer to the light emitting region 20a that emits the green light LG, the adhesive is less likely to be affected by the leakage light leaking to the outside from the incident opening 45 of the green light guide element 542. Thus, the leakage light is less likely to hit the adhesive, and the deterioration of the adhesive can be suppressed. Therefore, it is possible to suppress a decrease in bonding strength of the adhesive that bonds the adhesive surface 160 of the holding member 101 and the green light guide element 542.

Next, the details of the emission end portion 170 will be described. As illustrated in FIGS. 3 and 8, the emission end portion 170 includes the ends at the +Z side of the first side surface portion 111, the second side surface portion 112, the third side surface portion 113, and the fourth side surface portion 114. The emission end portion 170 has recesses 171 and 172 and a holding portion 180.

The recess 171 is formed at the center at the +Z side of the first side surface portion 111. The recess 171 is recessed to the -Z side with respect to the emission end portion 170. The recess 171 has a substantially rectangular shape having a longitudinal direction along the X direction and a lateral direction along the Y direction when viewed from the Y direction. The recess 171 is provided at the +Z side of the first adhesive surface portion 161. The length of the recess 171 in the longitudinal direction is the same as the length of the first adhesive surface portion 161 in the longitudinal direction. The end of the recess 171 at the -Z side is coupled to the first adhesive surface portion 161 via a step recessed to the -Z side with respect to the recess 171.

The recess 172 is formed at the center at the +Z side of the third side surface portion 113. The recess 172 is recessed to the -Z side with respect to the emission end portion 170. The recess 172 has a substantially rectangular shape having a longitudinal direction along the X direction and a lateral direction along the Y direction when viewed from the Y direction. The recess 172 is provided at the +Z side of the second adhesive surface portion 162. The length of the recess 172 in the longitudinal direction is the same as the length of the second adhesive surface portion 162 in the longitudinal direction. The end of the recess 172 at the -Z side is coupled to the second adhesive surface portion 162 via a step recessed to the -Z side with respect to the recess 172.

The holding portion 180 holds the green parallelizing element 562 on the holding member 101. The holding portion 180 corresponds to the shape of the green parallelizing element 562 as a whole, and is a recess formed in the emission end portion 170. The holding portion 180 includes first holding portions 181a and 181b, a second holding portion 182, third holding portions 183a and 183b, and a fourth holding portion 184. The first holding portions 181a and 181b and the third holding portions 183a and 183b have the same shape. The second holding portion 182 and the fourth holding portion 184 have the same shape.

The first holding portions 181a and 181b are steps provided at the +Z side of the first side surface portion 111 and recessed toward the -Z side with respect to the emission end portion 170.

The first holding portion 181a is provided at the -X side and the -Y side of the first side surface portion 111. The first holding portion 181a extends from the -X side toward the +X side to the recess 171. The end of the first holding portion 181a at the -X side is formed in an arc shape.

The first holding portion 181b is provided at the +X side and the -Y side of the first side surface portion 111. The first holding portion 181b extends from the +X side toward the -X side to the recess 171. The end of the first holding portion 181b at the +X side is formed in an arc shape.

The second holding portion 182 is provided at the center at the +X side of the second side surface portion 112. The second holding portion 182 is recessed toward the -Z side with respect to the emission end portion 170 as a whole. The second holding portion 182 includes a central portion 182a extending along the Y direction and placement portions 182b and 182c on which the green parallelizing element 562 is placed.

The central portion 182a extends along the Y direction, and the ends at the +Y side and the -Y side are formed in arc shapes. The placement portions 182b and 182c are steps further recessed toward the -Z side than the central portion 182a. The placement portion 182b is formed at the end at the +Y side of the central portion 182a. The placement portion 182c is formed at the end at the -Y side of the central portion 182a. The placement portions 182b and 182c are formed in the arc shapes in accordance with the curvature of the green parallelizing element 562.

A lens holding member 185 that holds the green parallelizing element 562 on the second holding portion 182 is provided in the central portion 182a. The lens holding member 185 corresponds to the shape of the central portion 182a, and fixes the position of the green parallelizing element 562 placed in the placement portions 182b and 182c.

The third holding portions 183a and 183b are steps provided at the +Z side of the third side surface portion 113 and recessed toward the -Z side with respect to the emission end portion 170.

The third holding portion 183a is provided at the -X side and the -Y side of the third side surface portion 113. The third holding portion 183a extends from the -X side toward the +X side to the recess 172. The end of the third holding portion 183a at the -X side is formed in an arc shape.

The third holding portion 183b is provided at the +X side and the -Y side of the third side surface portion 113. The third holding portion 183b extends from the +X side toward the -X side to the recess 172. The end of the third holding portion 183b at the +X side is formed in an arc shape.

The fourth holding portion 184 is provided at the center at the -X side of the fourth side surface portion 114. The fourth holding portion 184 is recessed toward the -Z side with respect to the emission end portion 170 as a whole. The fourth holding portion 184 includes a central portion 184a extending along the Y direction and placement portions 184b and 184c on which the green parallelizing element 562 is placed.

The central portion 184a extends along the Y direction, and the ends at the +Y side and the -Y side are formed in arc shapes. The placement portions 184b and 184c are steps further recessed toward the -Z side than the central portion 184a. The placement portion 184b is formed at the end at the +Y side of the central portion 184a. The placement portion 184c is formed at the end at the -Y side of the central portion 184a. The placement portions 184b and 184c are formed in the arc shapes in accordance with the curvature of the green parallelizing element 562.

A lens holding member 186 that holds the green parallelizing element 562 on the fourth holding portion 184 is provided in the central portion 184a. The lens holding member 186 corresponds to the shape of the central portion 184a, and fixes the position of the green parallelizing element 562 placed in the placement portions 184b and 184c.

The green parallelizing element 562 is a condenser lens that is provided in the emission end portion 170 and parallelizes the green light LG emitted from the green light guide element 542 along the Z direction. The green parallelizing element 562 has a linear edge along the X direction and an arc-shaped edge along the Y direction. The green parallelizing element 562 has a thickness in the Z direction. The green parallelizing element 562 is fixed to the holding member 101 by the holding portion 180.

More specifically, the edge at the +Y side of the green parallelizing element 562 is held by the first holding portions 181a and 181b. The edge of the green parallelizing element 562 at the -X side is held by the second holding portion 182. The edge of the green parallelizing element 562 at the -Y side is held by the third holding portions 183a and 183b. The edge of the green parallelizing element 562 at the +X side is held by the fourth holding portion 184.

According to the configuration, the green parallelizing element 562 is fixed to the holding member 101 that holds the green light guide element 542. Therefore, it is not necessary to separately provide components for holding the green light guide element 542 and the green parallelizing element 562, and the holding member 101 can be shared.

Although not illustrated, the green light modulation device 505 may be directly attached to the emission end portion 170.

As described above, the green light source module 500G of the present embodiment includes the substrate 512b having the green light emitting element 512a that emits the green light LG, the green light guide element 542 having the incident end 41a on which the green light LG emitted from the green light emitting element 512a is incident and the emission end 41b that emits the green light LG and uniformizing in-plane illuminance of the green light LG, and the holding member 101 that holds the green light guide element 542, wherein the holding member 101 is fixed to the substrate 512b, the holding member 101 has the wall portion 110 forming the side surface surrounding the green light guide element 542, the incident end portion 140 facing the substrate 512b in the wall portion 110, and the emission end portion 170 located at the side opposite to the incident end portion 140, the incident end portion 140 and the emission end portion 170 penetrate along the optical axis direction of the green light LG, and the wall portion 110 has the opening portions 112a and 114a that overlap the green light guide element 542 when viewed from the direction intersecting the optical axis direction of the green light LG.

According to the green light source module 500G of the present embodiment, the holding member 101 holding the green light guide element 542 is fixed to the substrate 512b having the green light emitting element 512a. Therefore, the configuration of the green light source module 500G can be reduced in size. In addition, since the opening portions 112a and 114a into which the jig for adjusting the position of the green light guide element 542 with respect to the green light emitting element 512a is inserted are provided, the position of the green light guide element 542 can be adjusted with respect to the green light emitting element 512a with high accuracy. Accordingly, a larger amount of the green light LG emitted from the green light emitting element 512a can be incident on the green light guide element 542. Therefore, the light use efficiency can be improved.

Next, the blue image forming module 520 will be described. The blue light source module 500B of the blue image forming module 520 includes a blue light source 511, a blue light guide element 541, and a blue parallelizing element 561. The blue light source module 500B has the same configuration as the green light source module 500G.

The blue light source 511 includes a blue light emitting element 511a and a blue substrate 511b on which the blue light emitting element 511a is mounted.

The blue substrate 511b has the blue light emitting element 511a. The blue light emitting element 511a emits the blue light LB. The blue light LB emitted from the blue light emitting element 511a travels to the -X side along the X direction.

The blue light emitting element 511a is supported by the blue substrate 511b. The blue substrate 511b is a plate parallel to a plane including the Y direction and the Z direction. The configuration of the blue substrate 511b is the same as that of the substrate 512b.

The blue light emitting element 511a is provided on a plate surface at the -X side in the blue substrate 511b. The light emitting surface of the blue light emitting element 511a is a surface at the -X side. The blue light emitting element 511a emits the blue light LB in a blue wavelength band in the visible wavelength band. The blue light LB is emitted to the -X side with an axis passing through the center of the light emitting surface of the blue light emitting element 511a and being parallel to the X direction as a center. The blue wavelength band is, for example, a wavelength band ranging from 420 nm to 500 nm. The light in the blue wavelength band has the shortest wavelength of the color lights used in the 3-LCD projector, and therefore has higher energy.

The blue light guide element 541 is provided in the optical path of the blue light LB emitted from the blue light emitting element 511a and is disposed at the -X side of the blue light emitting element 511a. The configuration of the blue light guide element 541 is the same as the green light guide element 542, and has a light guide path that guides the blue light LB.

The blue parallelizing element 561 is provided in the optical path of the blue light LB emitted from the blue light guide element 541. The blue parallelizing element 561 parallelizes the blue light LB emitted from the blue light guide element 541 along the X direction.

The blue light modulation device 504 includes a blue light incident-side polarization element 571, a blue light modulation element 581, and a blue light exiting-side polarization element 575. The blue light modulation device 504 is provided in the optical path of the blue light LB emitted from the blue parallelizing element 561.

The blue light incident-side polarization element 571 is disposed at the -X side of the blue parallelizing element 561. The blue light incident-side polarization element 571 emits predetermined polarized light of the blue light LB emitted from the blue parallelizing element 561 toward the -X side along the X direction. The blue light incident-side polarization element 571 is, for example, a reflective or absorptive polarizer.

The blue light modulation element 581 is disposed at the -X side of the blue light incident-side polarization element 571. The blue light modulation element 581 modulates the blue light LB emitted from the blue light incident-side polarization element 571. The blue light modulation element 581 is, for example, a transmissive liquid crystal panel. The liquid crystal panel forming the blue light modulation element 581 generates the blue image light IB by modulating the light based on blue image information. The blue light modulation element 581 emits the generated image light IB to the -X side along the X direction.

The blue light exiting-side polarization element 575 is disposed at the -X side of the blue light modulation element 581. The blue light exiting-side polarization element 575 emits predetermined polarized light of the image light IB emitted from the blue light modulation element 581 to the -X side along the X direction. The blue light exiting-side polarization element 575 is, for example, a reflective or absorptive polarizer.

As described above, the blue light source module 500B of the present embodiment has the blue light source 511, the blue light guide element 541, and the blue parallelizing element 561.

The configuration of the blue light source module 500B of the present embodiment is the same as that of the green light source module 500G. Therefore, similarly to the green light source module 500G, the blue light source module 500B can cause a larger amount of the blue light LB emitted from the blue light emitting element 511a to be incident on the blue light guide element 541, and can improve the light use efficiency.

Next, the red image forming module 530 will be described. The red light source module 500R of the red image forming module 530 has a red light source 513, a red light guide element 543, and a red parallelizing element 563. The red light source module 500R has the same configuration as the green light source module 500G.

The red light source 513 has a red light emitting element 513a and a red substrate 513b on which the red light emitting element 513a is mounted.

The red substrate 513b has the red light emitting element 513a. The red light emitting element 513a emits the red light LR. The red light LR emitted from the red light emitting element 513a travels to the +X side along the X direction.

The red light emitting element 513a is supported by the red substrate 513b. The red substrate 513b is a plate parallel to a plane including the Y direction and the Z direction. The configuration of the red substrate 513b is the same as that of the substrate 512b.

The red light emitting element 513a is provided on the plate surface at the +X side in the red substrate 513b. The light emitting surface of the red light emitting element 513a is a surface at the +X side. The red light emitting element 513a emits the red light LR in a red wavelength band in the visible wavelength band. The red light LR is emitted to the +X side with an axis passing through the center of the light emitting surface of the red light emitting element 513a and being parallel to the X direction as a center. The red wavelength band is, for example, a wavelength band ranging from 610 nm to 700 nm.

The red light guide element 543 is provided in the optical path of the red light LR emitted from the red light emitting element 513a and is disposed at the +X side of the red light emitting element 513a. The configuration of the red light guide element 543 is the same as that of the green light guide element 542, and has a light guide path that guides the red light LR.

The red parallelizing element 563 is provided in the optical path of the red light LR emitted from the red light guide element 543. The red parallelizing element 563 parallelizes the red light LR emitted from the red light guide element 543 along the X direction.

The red light modulation device 506 has a red light incident-side polarization element 573, a red light modulation element 583, and a red light exiting-side polarization element 577. The red light modulation device 506 is provided in the optical path of the red light LR emitted from the red parallelizing element 563.

The red light incident-side polarization element 573 is disposed at the +X side of the red parallelizing element 563. The red light incident-side polarization element 573 emits predetermined polarized light of the red light LR emitted from the red parallelizing element 563 toward the +X side along the X direction. The red light incident-side polarization element 573 is, for example, a reflective or absorptive polarizer.

The red light modulation element 583 is disposed at the +X side of the red light incident-side polarization element 573. The red light modulation element 583 modulates the red light LR emitted from the red light incident-side polarization element 573. The red light modulation element 583 is, for example, a transmissive liquid crystal panel. The liquid crystal panel forming the red light modulation element 583 generates a red image light IR by modulating the light based on red image information. The red light modulation element 583 emits the generated image light IR to the +X side along the X direction.

The red light exiting-side polarization element 577 is disposed at the +X side of the red light modulation element 583. The red light exiting-side polarization element 577 emits predetermined polarized light of the image light IR emitted from the red light modulation element 583 to the +X side along the X direction. The red light exiting-side polarization element 577 is, for example, a reflective or absorptive polarizer.

As described above, the red light source module 500R of the present embodiment has the red light source 513, the red light guide element 543, and the red parallelizing element 563.

The configuration of the red light source module 500R of the present embodiment is the same as that of the green light source module 500G. Therefore, similarly to the green light source module 500G, the red light source module 500R can cause a larger amount of the red light LR emitted from the red light emitting element 513a to be incident on the red light guide element 543, and can improve the light use efficiency.

Next, an assembly method for the green image forming module 510, the blue image forming module 520, and the red image forming module 530 of the present embodiment will be described. Since the green image forming module 510, the blue image forming module 520, and the red image forming module 530 have the same configuration, the green image forming module 510 will be described as an example.

Specifically, an assembly method for the green light source 512, the holding member 101, the green light guide element 542, and the green parallelizing element 562 will be described. The assembly method has seven steps described later.

In the first step, the holding member 101 and the substrate 512b of the green light source 512 are fastened and fixed by the first fixing member 223a and the third fixing member 223c.

Hereinafter, the first step will be specifically described.

First, the incident end portion 140 side of the holding member 101 and the +Z side surface of the substrate 512b are disposed to face each other. Subsequently, the positioning pin 224a is inserted into the positioning hole 24a, and the positioning pin 224b is inserted into the positioning hole 24b. When the positioning pins 224a and 224b are inserted into the positioning holes 24a and 24b, the positions of the holding member 101 and the substrate 512b in the X direction and the Y direction are determined. When the positioning is completed, the first fixing member 223a is inserted through the first through hole 23a1 of the first receiving portion 23a, and inserted into the first hole portion 122a of the first coupling portion 123a. The third fixing member 223c is inserted through the third through hole 23c1 of the third receiving portion 23c, and inserted into the third hole portion 122c of the third coupling portion 123c. When the holding member 101 and the substrate 512b are fastened and fixed, the positions of the holding member 101 and the substrate 512b in the Z direction are determined. Accordingly, the holding member 101 and the substrate 512b are directly coupled to each other.

In the second step, the green light guide element 542 is inserted into the holding member 101.

The green light guide element 542 is inserted in an orientation in which the incident end 41a is located at the incident end portion 140 side of the holding member 101 and the first member 11 is located at the first side surface portion 111 side. The guide portion 150 guides the insertion position of the green light guide element 542 inside the holding member 101. Here, the green light guide element 542 is movable in the X direction, the Y direction, and the Z direction inside the holding member 101.

In the third step, a jig for moving the green light guide element 542 inside the holding member 101 is inserted from the opening portions 112a and 114a.

The jig inserted through the opening portions 112a and 114a sandwiches the ends of the first member 11 and the third member 13 of the green light guide element 542, respectively.

The width between the ends of the first member 11 and the third member 13 of the green light guide element 542 decreases toward the incident end 41a. The opening portions 112a and 114a are provided at the incident end portion 140 side of the holding member 101. Accordingly, the jig inserted through the opening portions 112a and 114a can sandwich the green light guide element 542 at a position where the width between the ends of the first member 11 and the third member 13 is smaller. Therefore, an increase in size of the jig can be suppressed, and the opening portions 112a and 114a can be formed to be smaller.

The green light guide element 542 includes a pair of rectangular plate members and a pair of trapezoidal plate members. The opening portions 112a and 114a are provided to face the ends of the first member 11 and the third member 13 of the green light guide element 542. If the green light guide element 542 is formed of only trapezoidal plate members, the jig and the sandwiched portions of the green light guide element 542 are obliquely arranged. In contrast, in the present embodiment, the jig and the sandwiched portions of the green light guide element 542 are disposed substantially parallel to each other. Therefore, the jig easily sandwiches the green light guide element 542.

In the fourth step, optical axis adjustment of the green light guide element 542 with respect to the light emitting region 20a in the X direction and the Y direction is performed.

First, the green light guide element 542 is moved from the emission opening 46 side of the green light guide element 542 so that the light emitting region 20a is located inside the incident opening 45 of the green light guide element 542 by using an imaging device such as a camera, for example. Here, in order to align the optical axis of the green light LG emitted from the light emitting region 20a with the optical axis of the green light guide element 542, the position of the green light guide element 542 is further adjusted such that the surface of the light emitting region 20a is orthogonal to the Z axis. Thus, the optical axis adjustment of the green light guide element 542 with respect to the light emitting region 20a in the X direction and the Y direction is completed.

In the fifth step, optical axis adjustment of the green light guide element 542 with respect to the light emitting region 20a in the Z direction is performed. Specifically, the position of the green light guide element 542 in the Z direction is adjusted using a jig.

The jig moves the green light guide element 542 toward the green light emitting element 512a along the Z direction. The green light guide element 542 stops at a position where no gap is formed between the green light guide element 542 and the green light emitting element 512a in the Z direction. Thus, the optical axis adjustment of the green light guide element 542 with respect to the light emitting region 20a in the Z direction is completed.

In the sixth step, the green light guide element 542 is bonded to the adhesive surface 160 of the holding member 101.

As illustrated in FIG. 7, the nozzle Nz for injecting an adhesive is inserted into the gaps formed between the first adhesive surface portion 161 and the first member 11 and between the second adhesive surface portion 162 and the third member 13. The nozzle Nz is inserted along the surfaces of the first member 11 and the third member 13 in the green light guide element 542, and applies the adhesive to the adhesive surface 160. That is, the green light guide element 542 is bonded to the adhesive surface 160 after the position adjustment is performed inside the holding member 101. Thus, the green light guide element 542 is fixed to the holding member 101.

In the seventh step, the green parallelizing element 562 is fixed to the emission end portion 170 of the holding member 101.

First, the green parallelizing element 562 is disposed with the convex surface thereof facing the +Z side. The edge of the green parallelizing element 562 is placed on the holding portion 180. The edge of the green parallelizing element 562 is fixed to the second holding portion 182 and the fourth holding portion 184 by the lens holding members 185 and 186. Thus, the green parallelizing element 562 is fixed to the holding member 101.

The green image forming module 510 can be assembled by performing the first to seventh steps described above.

As described above, the projector 501 of the present embodiment includes the green light source module 500G, the blue light source module 500B, the red light source module 500R, the light combining element 500 that combines the lights emitted from the light source modules 500G, 500B, and 500R and emits the combined light, and the projection optical system 550 that projects the light emitted from the light combining element 500.

Since the projector 501 of the present embodiment includes the light source modules 500G, 500B, and 500R corresponding to the three colors, it is possible to provide a projector capable of improving the light use efficiency.

Some preferable embodiments of the present disclosure have been described hereinabove in detail. However, the present disclosure is not limited to such specific embodiments, and various modifications and changes can be made thereto within the scope of the present disclosure set forth in the appended claims.

Note that, in the present embodiment, the case where the plurality of plate members 10 include the four plate members is described, however, the plurality of plate members 10 may include two plate members. More specifically, the first member 11 and the second member 12 may be integrally formed. Similarly, the third member 13 and the fourth member 14 may be integrally formed.

For example, the green light guide element 542 may be a reflector made of a transparent material having a refractive index higher than the air, such as optical glass and quartz, or may be formed as a solid member. When the green light guide element 542 is a solid member formed of a transparent member, the reflection surface 10a is formed with a side surface facing the outside of the solid member. Most of the green light LG incident on the green light guide element 542 from the incident end 41a is totally reflected by the reflection surface 10a toward the emission end 41b. The blue light guide element 541 and the red light guide element 543 may have the same configuration as the green light guide element 542 described above.

The present disclosure will be summarized below as appendices.

### Appendix 1

A light source module includes a light source including a light emitting element that emits a light and a substrate on which the light emitting element is mounted, a light guide element having an incident end on which the light emitted from the light source is incident and an emission end from which the light is emitted, and uniformizing in-plane illuminance of the light, and a holding member holding the light guide element, wherein the holding member is fixed to the substrate of the light source, the holding member has a wall portion forming a side surface surrounding the light guide element, an incident end portion facing the light source in the wall portion, and an emission end portion located at a side opposite to the incident end portion, the incident end portion and the emission end portion penetrate along an optical axis direction of the light, and the wall portion has an opening overlapping the light guide element when viewed from a direction intersecting the optical axis direction of the light.

According to the light source module having the configuration, the holding member holding the light guide element is fixed to the substrate having the light emitting element. Accordingly, the configuration of the light source module can be reduced in size. In addition, since the opening into which the jig for adjusting the position of the light guide element with respect to the light emitting element is inserted is provided, the position of the light guide element can be adjusted with respect to the light emitting element with high accuracy. Thus, a larger amount of the light emitted from the light emitting element can be incident on the light guide element. Therefore, the light use efficiency can be improved.

### Appendix 2

In the light source module according to Appendix 1, the holding member has a plurality of coupling portions at the substrate side, the substrate has a plurality of receiving portions coupled to the coupling portions via fixing members, and the plurality of coupling portions and the plurality of receiving portions are coupled to each other via the fixing members, thereby directly fixing the substrate to the holding member.

According to the configuration, since the substrate can be directly fixed to the holding member, the accuracy of the optical axis adjustment between the holding member and the substrate can be improved. Furthermore, the substrate and the holding member can be stably fixed. In addition, since the substrate and the holding member are directly fixed to each other and integrated, an increase in the number of components can be suppressed.

### Appendix 3

In the light source module according to Appendix 2, the plurality of coupling portions include a first coupling portion, a second coupling portion, a third coupling portion, and a fourth coupling portion,

the plurality of receiving portions include a first receiving portion, a second receiving portion, a third receiving portion, and a fourth receiving portion, and

each of the plurality of coupling portions and each of the plurality of receiving portions are disposed to surround the light source.

According to the configuration, the plurality of coupling portions and the plurality of receiving portions are arranged at equal intervals from the light emitting element. Accordingly, the light emitting element can be stably supported. Therefore, the substrate and the holding member can be stably fixed.

The plurality of coupling portions and the plurality of receiving portions can be arranged to surround the light emitting element. Therefore, the light emitting element can be stably provided on the substrate.

### Appendix 4

In the light source module according to Appendix 3, the light source further includes a structure disposed on the substrate to drive the light emitting element, the wall portion includes a flange portion extending along the substrate from the incident end portion facing the structure, the flange portion is provided continuously between the first coupling portion and the second coupling portion, and the flange portion is disposed with a predetermined space between the substrate and itself.

According to the configuration, the coupling strength between the first coupling portion and the second coupling portion can be increased. Furthermore, the flange portion can prevent dust, dirt, or the like from entering from a predetermined space between the wall portion and the substrate.

### Appendix 5

In the light source module according to any one of Appendices 1 to 4, the holding member has a guide portion protruding into the wall portion.

According to the configuration, when the light guide element is disposed inside the holding member, the position of the light guide element can be guided.

### Appendix 6

In the light source module according to Appendix 5, the light guide element includes a plurality of plate members that define a light guide path that guides a light incident from the incident end and emits the light from the emission end, the plurality of plate members include a first member having a first reflection surface, a second member having a second reflection surface, a third member having a third reflection surface, and a fourth member having a fourth reflection surface, the first member and the third member include a pair of rectangular plate members, the second member and the fourth member include a pair of trapezoidal plate members, the light guide path is formed with the first reflection surface of the first member and the third reflection surface of the third member facing each other and the second reflection surface of the second member and the fourth reflection surface of the fourth member facing each other, upper bottom sides of the second member and the fourth member are located at the incident end side, lower bottom sides of the second member and the fourth member are located at the emission end side, the guide portion is disposed along surfaces of the first member and the third member, and a protrusion amount of the guide portion at the incident end portion side is larger than a protrusion amount of the guide portion at the emission end portion side.

According to the configuration, when the light guide element is disposed inside the holding member, the position of the light guide element can be further guided. Furthermore, the light guide element can increase the light flux width in the process of propagating the light incident from the incident end in the light guide path. Accordingly, a green light having a uniform illuminance distribution can be generated.

### Appendix 7

In the light source module according to Appendix 6, the opening faces ends of the first member and the third member and is located at the incident end side in the light guide element.

According to the configuration, when fixing the light guide element to the holding member, it is possible to finely adjust the position of the light guide element from the opening using a jig or the like after inserting the light guide element into the holding member. The width between the ends of the first member and the third member of the light guide element decreases toward the incident end side. The opening is provided at the incident end side of the holding member. Accordingly, the jig inserted through the opening can sandwich the light guide element at a position where the width between the end portions of the first member and the third member is smaller. Therefore, an increase in size of the jig can be suppressed, and the opening can be formed to be smaller. Furthermore, the light guide element includes a pair of rectangular plate members and a pair of trapezoidal plate members. The opening is provided to face the ends of the first member and the third member of the light guide element. If the light guide element is formed of only trapezoidal plate members, the jig and the sandwiched portions of the light guide element are obliquely arranged. In contrast, in the present disclosure, the jig and the sandwiched portions of the light guide element are disposed substantially parallel to each other. Therefore, the jig easily sandwiches the light guide element.

### Appendix 8

In the light source module according to any one of Appendices 1 to 7, the light guide element is fixed to the holding member with an adhesive.

According to the configuration, it is not necessary to provide a new component for fixing the light guide element to the holding member, and the number of components can be reduced.

### Appendix 9

In the light source module according to Appendix 8, the holding member has an adhesive surface on which the light guide element is held by the holding member, the adhesive surface and the light guide element are provided at a predetermined interval at which the adhesive is applied, and the adhesive surface is provided along a surface of the light guide element.

According to the configuration, since it is not necessary to provide a new component for fixing the light guide element to the holding member and it is necessary to provide only the gap for applying the adhesive, the number of components can be reduced and the holding member can be reduced in size. Furthermore, since the gap is formed between the adhesive surface and the light guide element, the adhesive can be applied after the light guide element is positioned to be fixed inside the holding member. Therefore, the position adjustment of the light guide element is easier inside the holding member.

### Appendix 10

In the light source module according to Appendix 9, the adhesive surface is provided at the emission end side.

According to the configuration, in comparison with a case where the adhesive surface is provided at the incident end portion side closer to the light emitting element that emits the light, the adhesive is less likely to be affected by the leakage light leaking to the outside from the incident end of the light guide element. Thus, the leakage light is less likely to hit the adhesive, and the deterioration of the adhesive can be suppressed. Therefore, it is possible to suppress a decrease in the bonding strength of the adhesive that bonds the adhesive surface of the holding member and the light guide element.

### Appendix 11

The light source module according to any one of Appendices 1 to 10, further includes an optical element on which the light emitted from the light guide element is incident, wherein the holding member has a support portion that supports the optical element at the emission end portion side.

According to the configuration, it is not necessary to separately provide components for holding the light guide element and the optical element, and the holding member can be shared.

### Appendix 12

A projector includes the light source module according to any one of Appendices 1 to 11, a light combining element that combines a light emitted from the light source module and emits the combined light, and a projection optical system that projects the light emitted from the light combining element.

According to the projector having the configuration, it is possible to provide a projector capable of improving light use efficiency.

What is claimed is:

1. A light source module comprising:
a light source including a light emitting element that emits a light and a substrate on which the light emitting element is mounted;
a light guide element having an incident end on which the light emitted from the light source is incident and an emission end from which the light is emitted, and uniformizing in-plane illuminance of the light; and
a holding member holding the light guide element, wherein
the holding member is fixed to the substrate of the light source,
the holding member has a wall portion forming a side surface surrounding the light guide element, an incident end portion facing the light source in the wall portion, and an emission end portion located at a side opposite to the incident end portion,
the incident end portion and the emission end portion penetrate along an optical axis direction of the light, and
the wall portion has an opening overlapping the light guide element when viewed from a direction intersecting the optical axis direction of the light.

2. The light source module according to claim 1, wherein
the holding member has a plurality of coupling portions at the substrate side,
the substrate has a plurality of receiving portions coupled to the coupling portions via fixing members, and
the plurality of coupling portions and the plurality of receiving portions are coupled to each other via the fixing members, thereby directly fixing the substrate to the holding member.

3. The light source module according to claim 2, wherein
the plurality of coupling portions include a first coupling portion, a second coupling portion, a third coupling portion, and a fourth coupling portion,
the plurality of receiving portions include a first receiving portion, a second receiving portion, a third receiving portion, and a fourth receiving portion, and
each of the plurality of coupling portions and each of the plurality of receiving portions are disposed to surround the light source.

4. The light source module according to claim 3, wherein
the light source further includes a structure disposed on the substrate to drive the light emitting element,
the wall portion includes a flange portion extending along the substrate from the incident end portion facing the structure,
the flange portion is provided continuously between the first coupling portion and the second coupling portion, and
the flange portion is disposed with a predetermined space between the substrate and itself.

5. The light source module according to claim 1, wherein
the holding member has a guide portion protruding into the wall portion.

6. The light source module according to claim 5, wherein
the light guide element includes a plurality of plate members that define a light guide path that guides a light incident from the incident end and emits the light from the emission end,
the plurality of plate members include a first member having a first reflection surface, a second member having a second reflection surface, a third member having a third reflection surface, and a fourth member having a fourth reflection surface,
the first member and the third member include a pair of rectangular plate members,
the second member and the fourth member include a pair of trapezoidal plate members,
the light guide path is formed with the first reflection surface of the first member and the third reflection surface of the third member facing each other and the second reflection surface of the second member and the fourth reflection surface of the fourth member facing each other,
upper bottom sides of the second member and the fourth member are located at the incident end side,
lower bottom sides of the second member and the fourth member are located at the emission end side,
the guide portion is disposed along surfaces of the first member and the third member, and
a protrusion amount of the guide portion at the incident end portion side is larger than a protrusion amount of the guide portion at the emission end portion side.

7. The light source module according to claim 6, wherein
the opening faces ends of the first member and the third member and is located at the incident end side in the light guide element.

8. The light source module according to claim 1, wherein
the light guide element is fixed to the holding member with an adhesive.

9. The light source module according to claim 8, wherein
the holding member has an adhesive surface on which the light guide element is held by the holding member,
the adhesive surface and the light guide element are provided at a predetermined interval at which the adhesive is applied, and
the adhesive surface is provided along a surface of the light guide element.

10. The light source module according to claim 9, wherein
the adhesive surface is provided at the emission end side.

11. The light source module according to claim 1, further comprising an optical element on which the light emitted from the light guide element is incident, wherein
the holding member has a support portion that supports the optical element at the emission end portion side.

12. A projector comprising:
the light source module according to claim 1;
a light combining element that combines a light emitted from the light source module and emits the combined light; and
a projection optical system that projects the light emitted from the light combining element.
